(19) United States
(12) Patent Application Publication
(10) Pub. No.: US 2015/0065928 A1
(43) Pub. Date: Mar. 5, 2015

(54) Apparatus for Reducing the Appearance and Effects of Scars

(71) Applicant: ISOS Solutions, LLC, New Hampton, NY (US)

(72) Inventors: Dimitrios Christoforou, Middletown, NY (US); Vipul Patel, Middletown, NY (US)

(21) Appl. No.: 14/474,751

(22) Filed: Sep. 2, 2014

Related U.S. Application Data
(60) Provisional application No. 61/872,007, filed on Aug. 30, 2013.

(51) Int. Cl. A61H 7/00

(52) U.S. Cl. CPC A61H 7/003; A61H 2205/067
USPC 601/138

(57) ABSTRACT

The present disclosure is directed to a device that fits a person's finger and that can be used to reduce the effect, appearance, and/or sensitivity of a scar over a period of time. Aspects of the device include its form factor and material construction so that a contoured surface of the device fitted to a user's finger or fingers can be used to therapeutically rub an affected region of skin that is scarred. In a treatment regimen extending over a plurality of time periods, a plurality of devices in a set provide a system for systematically reducing a scar. Other aspects provide a therapeutic cream to aid in the healing and amelioration of said scar.

### RELATED APPLICATIONS

The present application is related to and claims the priority of U.S. Provisional Application No. 61/872,007, entitled “Scar Erasing Thimble and Scar Cream,” filed on Aug. 30, 2013, which is hereby incorporated by reference.

### TECHNICAL FIELD

The present application relates to devices for treating scars, and more particularly, for a textured apparatus that fits a person's finger and that can be used to reduce the effect and appearance of a scar over a period of time.

### BACKGROUND

A scar is a mark that remains on body tissue after it has been damaged. Scars commonly occur after injury to the body tissue, for example as a result of an accident, surgery, disease, or skin condition (e.g., acne). A scar can include tissue that is raised above the surrounding tissue, which can be unaesthetic if the scar is on a human's skin. In addition, scars are often discolored with respect to the surrounding skin. Another problem is that scars on sensitive areas, such as a finger, can be uncomfortable, painful or more susceptible to the same. Painful scars can cause a patient to avoid stimulating the scar area, which can result in the avoidance of use of the scar area (a finger, a hand, etc.) since motion, pressure, and/or tactile stimulation can increase pain in a scar. Furthermore, scars with poor aesthetic appearances can have negative social consequences (e.g., embarrassment, self-consciousness, etc.) for the patient.

It is recognized that rubbing a scar with a frictional tool could reduce the effects of or appearance of the scar in the long term. However, many existing systems for doing this are cumbersome, bulky, heavy, expensive and/or simply inconvenient to use, leaving persons with scars with few options to conveniently and inexpensively treat their scar tissue. In addition, many existing systems require a medical practitioner, such as an occupational therapist, to administer treatment in a formal medical setting (e.g., an office, hospital, etc.), which is less convenient and more expensive for the patient.

### SUMMARY

The present disclosure is directed to a device or a system including a device or devices that treat scars on the skin. The present devices and systems overcome many of the shortcomings of existing devices and systems for treating scars. In an aspect, the present device can improve fingertip hypersensitivity for isolated finger injuries. The embodiments described include convenient and effective form factors such as in the form of a wearable thimble with a textured outer surface that fits over one or more fingers that can apply the thimble to an affected area (scar). For some users the present device could aid in improving (reducing) the size of a scar, improving its appearance, reducing the pain from the scar, and improving edema, swelling and/or fingertip sensitivity of certain scars.

### IN THE DRAWINGS

FIG. 1 illustrates a perspective view of a scar treatment thimble according to an exemplary embodiment;

FIG. 2 illustrates another perspective view of a scar treatment thimble according to an exemplary embodiment;

FIG. 3 illustrates a side view of a scar treatment thimble according to an exemplary embodiment;

FIG. 4 illustrates a top view of a scar treatment thimble according to an exemplary embodiment;

FIG. 5 illustrates a multi-coarseness scar treatment thimble device according to an exemplary embodiment;

FIG. 6 illustrates a top view of a multi-coarseness scar treatment thimble device according to an exemplary embodiment;

FIG. 7 illustrates another side view of an exemplary scar treatment thimble device;

FIG. 8 illustrates a perspective view of another exemplary scar treatment thimble device;

FIG. 9 illustrates a side view of another exemplary scar treatment thimble device;

FIG. 10 illustrates a side view of another exemplary scar treatment thimble device;

FIGS. 11A and 11B illustrate a bottom view of exemplary scar treatment thimble devices;

FIG. 12 illustrates a side view of another exemplary scar treatment thimble device;

FIG. 13 illustrates application of a scar treatment thimble apparatus to a scar; and

FIG. 14 illustrates a configuration of scar treatment devices in a kit for personal scar care.

### DETAILED DESCRIPTION

The present disclosure is generally directed to devices and methods for treating localized dermatological conditions in humans and other animals using a wearable device for applying pressure and friction to the affected area. The conditions known to respond to the treatment include scars, burns, keloids, skin blemishes, incisions, lacerations, abrasions, and stretch marks.

A scar therapy kit is also disclosed and can be used as a tool for wound/laceration/incision/abrasion recovery by decreasing the appearance and sensitivity of traumatic and/or post-surgical scars throughout the body. For isolated finger injuries, it can also improve fingertip hypersensitivity and minimize scar formation as mentioned above. The kit comprises a scar treatment device or thimble and can comprise a therapeutic cream which could also be applied on and/or within a sheet or a pad. In an aspect, the kit and device allow a person with scar(s) to both actively and passively improve scar recovery.

In general, the wearable device includes a body having an interior surface and an exterior surface. The exterior surface includes features that provide one or more textured regions that a patient can rub against the affected area. The textured regions can have varying coarseness or roughness. The features can include raised bumps, grooves, or other shapes that have a coarseness appropriate for the skin condition and/or the treatment regimen. The textured regions can have features arranged in various patterns, which can have variations within the pattern such as the distance between each feature and adjacent features, the arrangement of the features (e.g., in linear columns and rows or an offset between adjacent columns and/or rows), and/or the hardness or flexibility of the material that creates the features. These variables, described above, can be the same or different across the textured region.

The body has a cavity to receive one or more fingers. A proximal end of the body defines an aperture to allow a finger to penetrate the cavity. The interior surface of the distal end of the body is adapted to conform to the tips of one or more fingers. Thus, a patient can mount the apparatus on a finger by inserting the finger(s) through the proximal end of the body and through the cavity to the distal end of the body.

The cavity can be cylindrical and can have a central axis extending from the proximal end to the distal end of the body. A support member can be disposed on the body to enhance the mechanical strength of the device. The support member can be disposed in an orientation orthogonal to the central axis.

As discussed above, the device has one or more textured regions. For example, a first textured region can have a coarseness appropriate for a first portion of a treatment regimen and a second textured region can have a coarseness appropriate for a second portion of the treatment regimen. The second textured region can have a greater or lower coarseness or roughness than the first textured region. The first and second textured regions can have other variations including the pattern of the features within each textured region, the distance between each feature, the arrangement of the features (e.g., in linear columns and rows or an offset between adjacent columns and/or rows), the distance between each feature and adjacent features, and/or the hardness or flexibility of the material that creates the features. In addition, a therapeutic cream can flow through interstices or channels of the first textured region at a first rate and a therapeutic cream can flow through interstices or channels of the second textured region at a second rate, thereby allowing the cream to flow through the textured regions at the same or different rates.

In addition, a kit with two or more devices is disclosed. A first device, similar to the devices described above, has at least one textured region having a first coarseness appropriate for a first portion of a treatment regimen. A second device, also similar to the devices described above, has at least one textured region having a second coarseness appropriate for a second portion of the treatment regimen. The kit can include additional devices having varying coarseness, which can be used for other portions of the treatment regimen. The kit can also include a cream to be used together or separately from the devices to treat the skin.

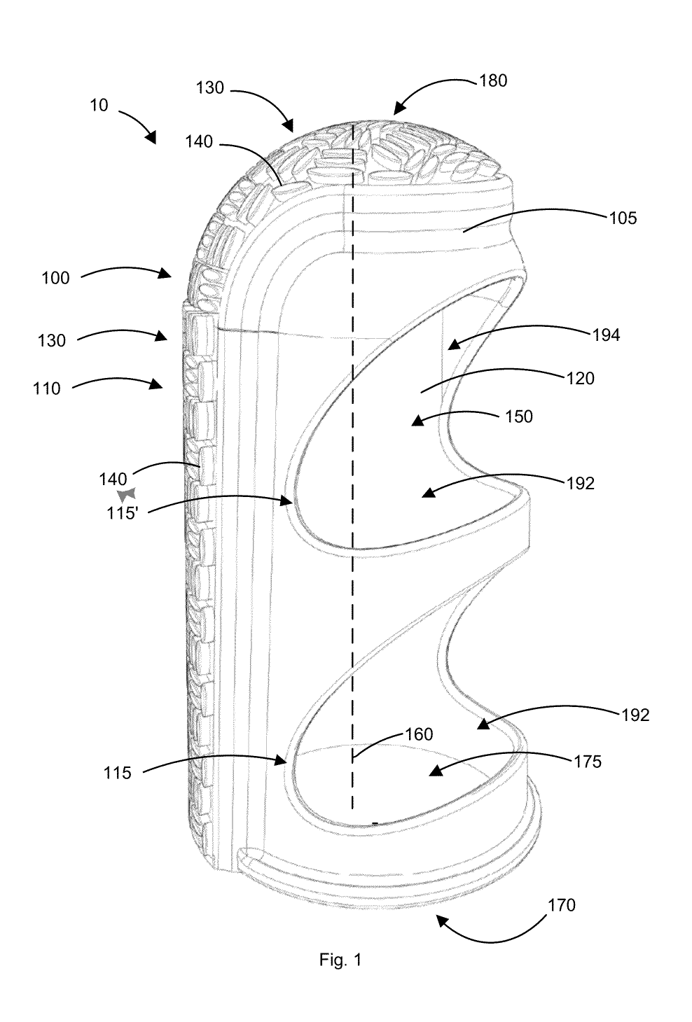

FIG. 1 illustrates an exemplary device 10 consistent with the present teachings to treat a localized dermatological condition, e.g., scars, burns, keloids, skin blemishes, and/or stretch marks. The device 10 includes a body 100 having an exterior surface 110 and an interior surface 120. The exterior surface 110 has a textured region 130 comprised of various raised features 140 that extend from the exterior surface 110. As illustrated in FIG. 1, the features 140 have an elongated shape such as oval prisms (i.e., a oval in one plane with a height in an orthogonal plane). In some embodiments, the features 140 can be raised bumps, grooves, ridges, spheres (or semi-spheres, spherical sections, etc.), cubes, parallelepipeds, cones, or other shape that provides an abrasive or textured surface. The features 140 can have a uniform shape (e.g., all oval prisms as illustrated in FIG. 1) or the features 140 can be a combination of two or more shapes, such as a combination of semi-spheres and cubes. Additionally, the features 140 can have a uniform shape but can be oriented in the same direction relative to each other or they can be oriented in two or more directions on the exterior surface 110. Alternatively, the features 140 can be formed from treating the exterior surface 110, such as by sand blasting, scraping, scratching, or other treatment to create a desired coarseness. In addition, the features 140 can be arranged to allow a therapeutic cream (not shown) to flow through the textured region 130, for example in the interstices or channels formed by the features 140.

The interior surface 120 of the body 100 is exposed to a cavity 150. The cavity 150 is generally sized to a finger of a patient (not shown). The distal end 180 of the interior surface 120 is shaped to conform to a tip of a finger. The cavity 150 has a central axis 160 that extends from a proximal end 170 to a distal end 180 of the body 100. Although the cavity 150 as illustrated in FIG. 1 is generally cylindrical, the cavity 150 can have other shapes such as a parallelepiped or a polyhedron prism (e.g., an octagon in one plane with a height in an orthogonal plane). In some embodiments, the body 100 is tapered from the proximal end 170 to the distal end 180, such that the body 100 is wider at the proximal end 170 and narrower at the distal end 180.

The body 100 defines an optional first opening 192 between the proximal end 170 of the body 100 and the support member 190. The body 100 further defines an optional second opening 194 between the distal end 180 of the body 100 and the support member 190. As illustrated in FIG. 1, the first opening 192 has approximately the same size and approximately the same shape as the second opening 194. In addition, as illustrated in FIG. 1, the first opening 192 and the second opening 194 are on the same “side” 105 of the body 100 so that they are substantially in alignment with each other along the circumference of the exterior surface 110 of the body 100. The openings 192 and 194 are located approximately 180 degrees from the features 140. However, other relative positions of the openings 192 and 194 and the features 140 are within the scope of this disclosure. For example, the features 140 can be disposed on the exterior surface 110 of the body 100 up to an edge 115 of the exterior surface 110 adjacent the first opening 192 and/or up to an edge 115′ of the exterior surface 110 adjacent the second opening 194. The optional first opening 192 and/or the optional second opening 194 can enhance the flexibility of the body 100 by decreasing the mechanical strength of the side 105. In addition, the optional first opening 192 and/or the optional second opening 194 can provide space for the body 100 to flex when a patient bends a finger in the cavity 150 towards the features 140 and away from the side 105. For example, the optional first opening 192 and/or the optional second opening 194 can be arranged to align and/or contour to a shape and/or position of the interphalangeal articulations/joints of the hand, which can enhance flexibility and/or comfort for the patient. In some embodiments, three or more openings are defined in the body 100.

The optional support member 190 is arranged in an orientation orthogonal to the central axis 160 along the circumference of the body 100, although other orientations (e.g., diagonal) are within the scope of the disclosure. The support member 190 can enhance the mechanical strength of the device 10.

The proximal end 170 of the body 100 defines an aperture 175 sized to allow a finger to pass through to the cavity 150. A patient can mount the device 10 on a finger by a fingertip through the aperture 175. The patient can then slide the device 10 down the finger through the cavity 150 so that the fingertip touches the interior surface 120 of the proximal end 180 of the body 100. The patient aligns the openings 192 and 194 with the back (nail side) of the finger so that the pad of the finger faces away from the openings 192 and 194 and towards the features 140. The patient then rubs the features 140 against a scar (or other dermatological condition) for treatment thereof. The textured surface 130 provides an abrasive force that can decrease the scar size and/or decrease the sensitivity of the scar as the scar heals, for example by re-training neuroreceptors connected to the scar tissue to be less sensitive. In addition or in the alternative, a patient can wear the device 10 on a finger that had a recent injury, trauma, or surgery during the healing process (e.g., at night). The device 10 can help retain moisture on the injured finger during healing, which can reduce scar sensitivity (e.g., by re-training neuroreceptors) and scar size.

The body 100 can be formed of a flexible or semi-flexible material such as silicone, fluoro-silicone, rubber, thermo-plastic rubber, polyurethane rubber, polyvinyl chloride (PVC), latex, polyisoprene, an elastomer, an elasto-plastic or other plastic or polymeric materials. The flexible or semi-flexible material can allow the body 100 to conform to the treatment area on a patient. For example, a flexible or semi-flexible material can allow the body 100 to conform to the shape of the skin on a patient's forearm where a scar may be located thereby increasing the surface area of the textured region 130 in contact with the treatment area (e.g., a wound site). In addition, a flexible or semi-flexible material can allow the interior surface 120 of the body 100 to conform to a patient's finger in the cavity 150 when the patient uses the device 10. Also, a flexible or semi-flexible material can be more comfortable to a patient when the device 10 is in contact with a wound site. In addition, a flexible or semi-flexible material can be gentler to a wounded area.

In some embodiments, the body 100 is formed of a rigid material such as polyethylene, polypropylene, PVC, a thermoplastic material, or other material described herein. The rigid material can enhance the application of a mechanical force applied by a patient to the treatment site using the device 10.

In some embodiments, the interior surface 120 of the body 100 has a “sticky” or frictional material (e.g., a rubber) that prevents a patient's finger from sliding along the interior surface 120 during use, thus allowing the patient's finger to stay engaged with the device 10 during treatment. The “sticky” or frictional material can also prevent the patient's finger from sliding in a direction parallel to the central axis 160 and/or from rotating about the central axis 160 in the cavity 150. For example, making the device 10 from a soft rubber substantially in the shape of a thimble and fitted snugly to securely fit over a finger can aid in the easy and secure application of the device to a patient's digit and keep it there while the device 10 is rubbed onto a scar.

In some embodiments, the body 100 is formed from two or more materials including the materials described above. For example, the body 100 can have an inner “core” made of a first material and an outer layer made of a second material. The inner “core” can be the portion of the body 100 exposed to the interior surface 120. Likewise, the outer layer can be the portion of the body 100 exposed to the exterior surface 110. In this way, the body 100 can be formed of materials having different properties. As an example, the inner “core” can be made out of a rigid material that has a “sticky” or frictional surface (e.g., a rubber) while the outer layer can be made out of a flexible material. An advantage of this approach is that the rigid material of the inner core increases the translation of mechanical force from a patient's finger to the treatment area while the flexible material of the outer layer increases the surface area of the textured region 130 in contact with the treatment site. The body 100 can include additional layers consistent with this disclosure. In another example, the body 100 can be formed out of two more materials in “strips” that run parallel to or perpendicular to the central axis 160, as discussed in more detail below.

The features 140 can be formed out of the same or a different material than the body 100 or a combination of different materials. In some embodiments, the features 140 are formed out of a flexible or semi-flexible material and the body 100 is formed out of a rigid material. In other embodiments, the features 140 are formed out of a rigid material and the body 100 is formed out of a flexible or semi-flexible material. In some embodiments, a first group of features 140 is made of a first material (e.g., a flexible material) and a second group of features 140 is made of a second material (e.g., a semi-flexible material) to allow a patient to select features having properties (e.g., flexibility or softness) appropriate for a treatment regimen. For example, a patient can select a gentler flexible material for a first portion of a treatment regimen (e.g., week 1) and an incrementally more rigid material (e.g., semi-flexible) for a second portion of a treatment regimen (e.g., week 2) and so on. In some embodiments, the features 140 are formed integrally with the body 100 during an injection molding or similar process. In addition, the features 140 can be arranged to allow a therapeutic cream (not shown) to flow through the textured region 130, for example in the interstices or channels formed between the features 140 and the patient's skin. The width of the interstices or channels can vary depending on the material of the features 140. For example, a wide channel (allowing flow of more cream thus increasing the cream's permeability into the skin both in quantity/time and surface area) can be formed when the features 140 are formed out of a rigid material. In contrast, a narrow channel (allowing for flow of less cream thus decreasing the cream's permeability into the skin both in quantity/time and surface area) can be formed when the features 140 are formed out of a flexible material.

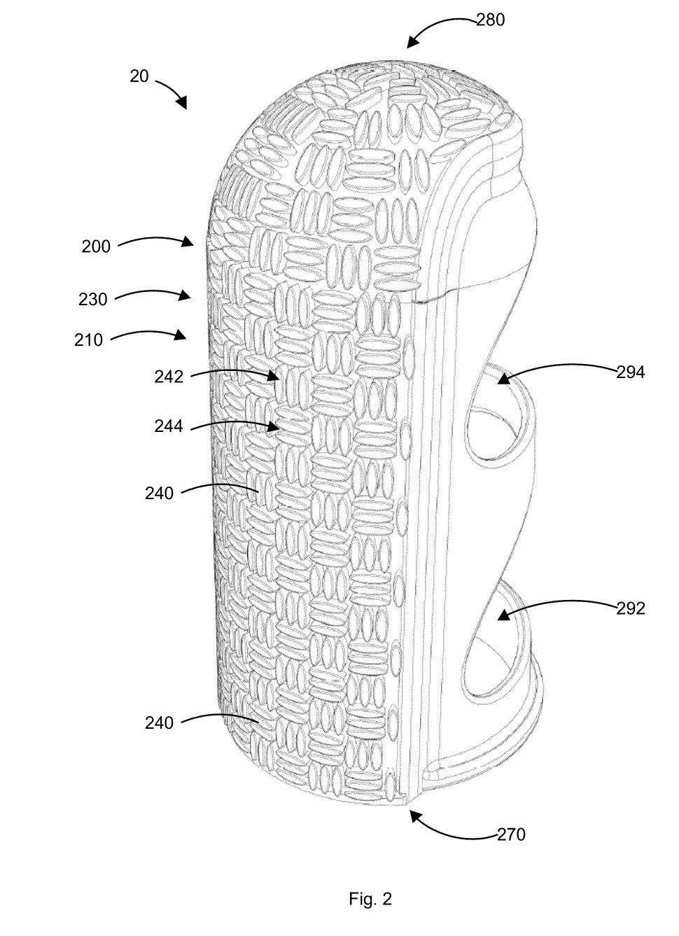

FIG. 2 illustrates a device 20 like the one shown in FIG. 1 but from a different perspective. The device 20 includes a textured region 230 on an exterior surface 210 of a body 200. The textured region 230 includes a plurality of features 240 having the same shape but arranged in a grid pattern based on orientation of the features 240. The grid includes a first group 242 of features 240 arranged in a first orientation and a second and a second group 244 of features 240 arranged in a second orientation. As illustrated in FIG. 2, the features 240 have an elongated shape (e.g., are oval prisms) though it is to be noted that this disclosure is not limited to a particular shape and that oval prisms are only provided as an example. The first group 242 of features 240 is oriented so that the elongated portion of the oval extends from a proximal end 170 to a distal end 180 of the body 200. The second group 244 of features 240 is oriented so that the elongated portion of the oval extends in a direction orthogonal to the elongated portion of ovals in the first group 242 of features 240. The relative orientation of the features 240 can affect the width and/or shape of the interstices or channels formed between the features 240 and the patient's skin. The relative orientation of the features 240 can also affect the coarseness of the textured region 230.

The first group 242 of features 240 is adjacent to the second group 244 of features 240. As illustrated, the first group 242 and the second group 244 are arranged on the exterior surface 210 in a repeating, grid-like pattern to form the textured region 230. It should be noted that other orientations of the features 240 and/or groups of features 240 are included within this disclosure. For example, the first group 242 can include a set of three features 240 where the outer features 240 have one orientation and the inner feature 240 has a different orientation. Likewise, the features 240 in the first group 242 can each have a different orientation. The first group can have additional or fewer features 240 than the three features 240 illustrated in FIG. 2, such as four features 240 or two features 240. Similar variations can be made with respect to the second group 244 of features 240. In some embodiments, the features 240 are divided into three or more groups and arranged in various orientations and/or shapes within each group as described above.

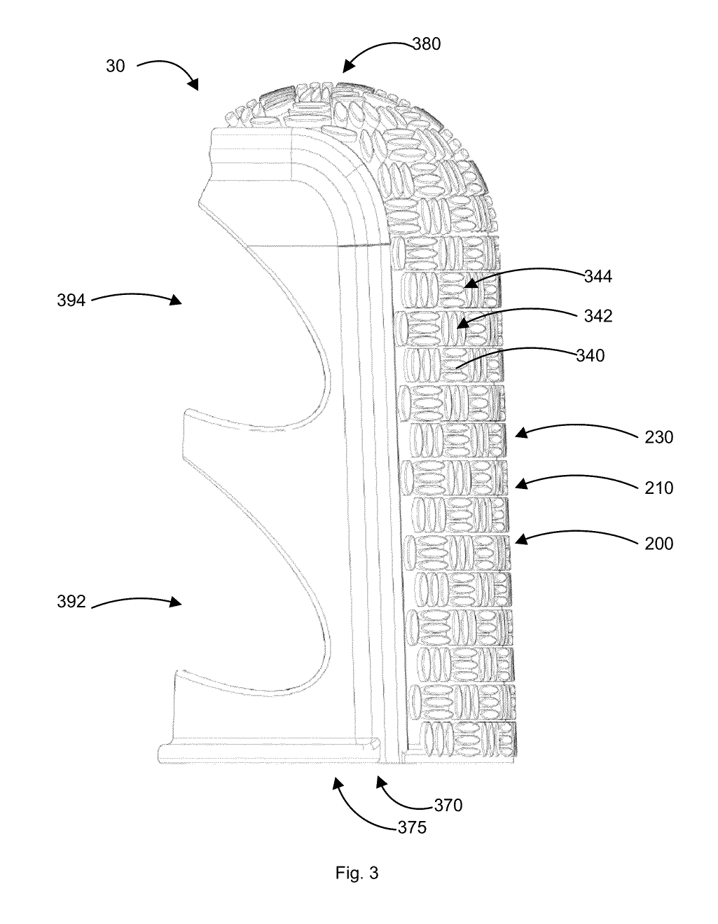

FIG. 3 illustrates another exemplary perspective of a device 30 similar to the devices 10 and 20 illustrated in FIGS. 1 and 2, respectively.

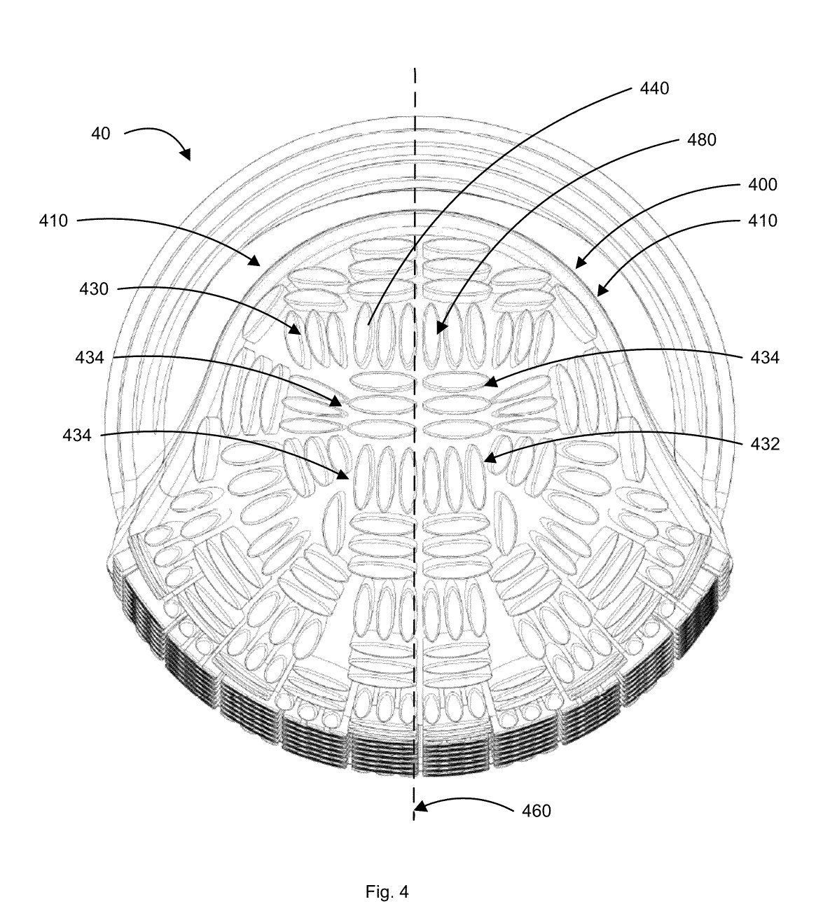

FIG. 4 illustrates a top view of a device 40 similar to the devices 10, 20, and 30 illustrated in FIGS. 1, 2, and 3, respectively. As shown in FIG. 3, textured region 430 optionally extends to the distal portion 480 of the body 400. The textured region 430 includes a first group 432 of features 440 and a second group 434 of features 440. The first group 432 of features 440 is disposed laterally from another first group 432 of features 440 with respect to an axis 460. Above and below the first group 432 of features 440, with respect to the axis 460, are a pair of the second group 434 of features 440. Additional arrangements of the first group 432 and the second 434 of features 440 are contemplated within this disclosure, as discussed above, including additional groups of features 440 and a different number of features 440 in each group. The features 440 can be arranged to form a channel within the features 440 and/or between the features 440 and the treatment area to allow a cream to flow there through.

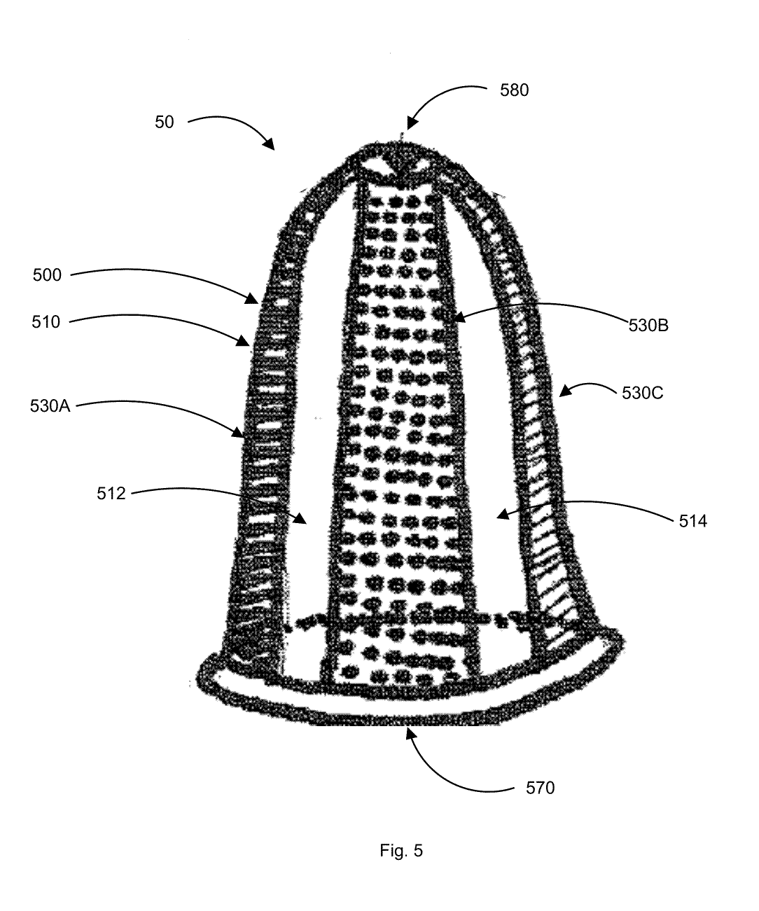

FIG. 5 illustrates another embodiment of a device 50. The device 50 has a generally cylindrical body 500 having an exterior surface 510 and an interior surface (not shown). Textured regions 530A, 530B, and 530C are on the exterior surface 510. The textured regions 530A, 530B, and 530C extend vertically from a proximal end 570 to a distal end 580 of the body 500. The textured regions 530A, 530B, and 530C are arranged laterally across a circumference of the exterior surface 510 of the body 500. Optionally, a plain or non-textured region 512 is disposed between textured regions 530A and 530B. Another optional plain or non-textured region 514 is disposed between textured regions 530B and 530C. In some embodiments, the textured region 530A is adjacent to the textured region 530B without the optional plain or non-textured region 512 between the textured regions 530A and 530B. Likewise, the textured region 530B can be adjacent to the textured region 530C without the optional plain or non-textured texture 514 between the textured regions 530B and 530C. The textured regions 530A, 530B, and 530C can be made out of the same material (e.g., with different sizes or shapes of features 540 (not shown)) or they can be made out of different materials (e.g., materials with different flexibilities or softness as discussed above).

The textured regions 530A, 530B, and 530C can have the same coarseness or they can each have a different coarseness. For example, textured region 530 can have a first coarseness, textured region 530B can have a second coarseness, and textured region 530C can have a third coarseness, and so on. In some embodiments, textured region 530C is coarser than textured region 530B, and textured region 530B is coarser than textured region 530A. In this way, a patient can use the device 50 for a treatment plan or regimen having three portions (e.g., a three-week treatment regimen, a six-week treatment regimen, etc.). In the first treatment portion (e.g., the first 1-2 weeks), a patient can use textured region 530A to treat a scar such as by rubbing textured region 530A against the scar. Textured region 530A can have a fine or non-rough coarseness to gently treat the scar as it first starts to heal and/or while the scar has increased sensitivity. In the second treatment portion (e.g., the second 1-2 weeks), the patient can use textured region 530B to treat the scar such as by rubbing textured region 530B against the scar. Textured region 530B can have an incrementally rougher or greater coarseness than textured region 530A, which allows the patient to apply a greater abrasive force to the scar (e.g., since the wound has healed more and is less sensitive since the first treatment portion) by using textured region 530B instead of textured region 530A. In the third portion (e.g., the third 1-2 weeks), the patient can use textured region 530C to treat the scar, such as by rubbing textured region 530C against the scar. Textured region 530C can have an incrementally rougher or greater coarseness than textured region 530B, which allows the patient to apply a greater abrasive force to the scar (e.g., since the wound has healed more and is less sensitive than it was in the second treatment portion) by using textured region 530C instead of textured region 530B. Greater or fewer textured regions 530N (not shown) can be included in the device 50 for additional or fewer treatment portions, or they can be used in combination during the same treatment portion (e.g., textured regions 530A and 530B are both used during week 1 of treatment). A treatment regimen such as the one described above can decrease the scar size and/or decrease the sensitivity of the scar tissue.

Alternatively, treatment portions 530A, 530B, and 530C can be disposed in bands along the circumference of the exterior surface 510 of the body 500. For example, textured region 530A can be in a first band adjacent to the proximal end 570 of the body 500. Textured region 530B can be in a second band adjacent to the first band, where the second band is located transversely from the first band in the direction of the distal end 580 of the body 500. Similarly, textured region 530C can be in a third band adjacent to the second band, where the third band is located transversely from the second band in the direction of the distal end 580 of the body 500. The bands can be made out of the same material or different materials as described above.

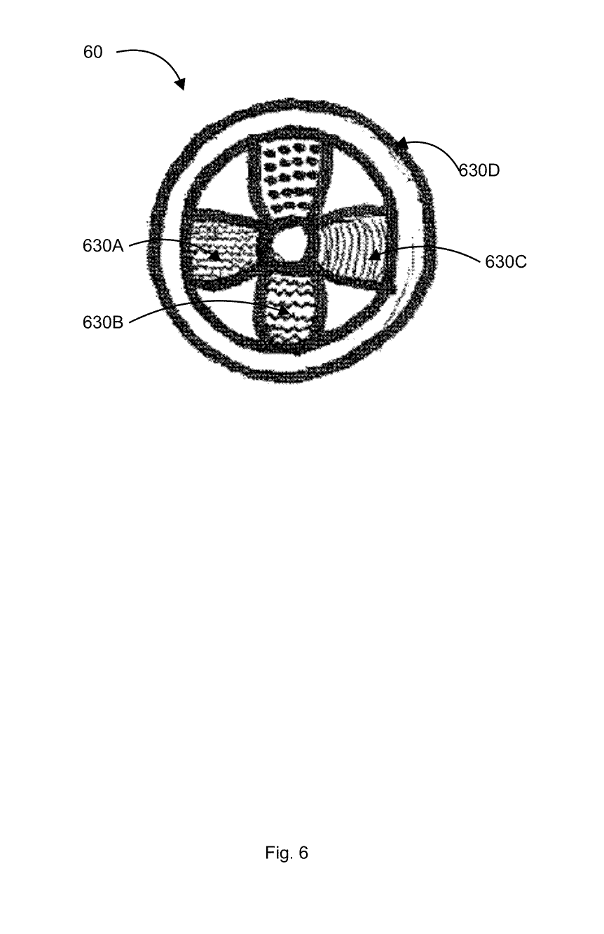

FIG. 6 illustrates a bottom view of a device 60 similar to the device 50 illustrated in FIG. 5. The device 60 includes a body 600 having an exterior surface (not shown) with textured regions 630A, 630B, 630C, and 630D. The textured regions 630A, 630B, 630C, and 630D can each have a different roughness, the same roughness, or combination thereof (e.g., two textured regions have the same roughness and two textured regions a different roughness). In addition, the textured regions 630A, 630B, 630C, and 630D can be made out of the same material or different material as discussed above.

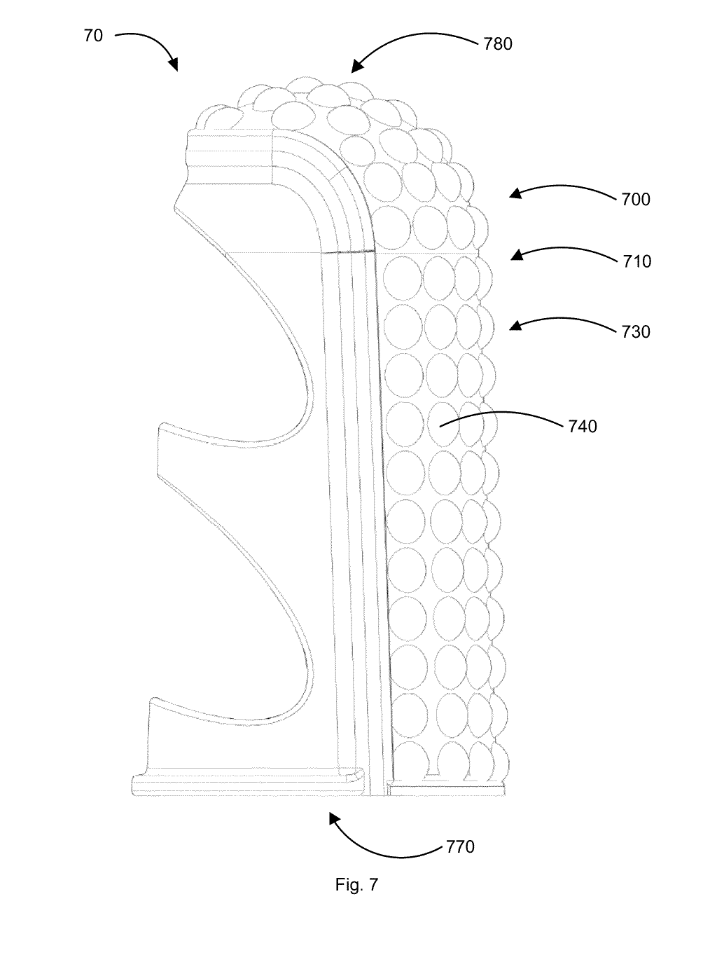

FIG. 7 illustrates a perspective view of a device 70. The device 70 has a textured region 730 on an exterior surface 710 of a body 700. The textured region 730 is comprised of semi-spherical features 740 having a given coarseness or roughness. The coarseness of the textured region 730 can be modified by adjusting the radius of the semi-spherical features 740, and/or by varying the distance between adjacent features 740 and/or the material of the features 740.

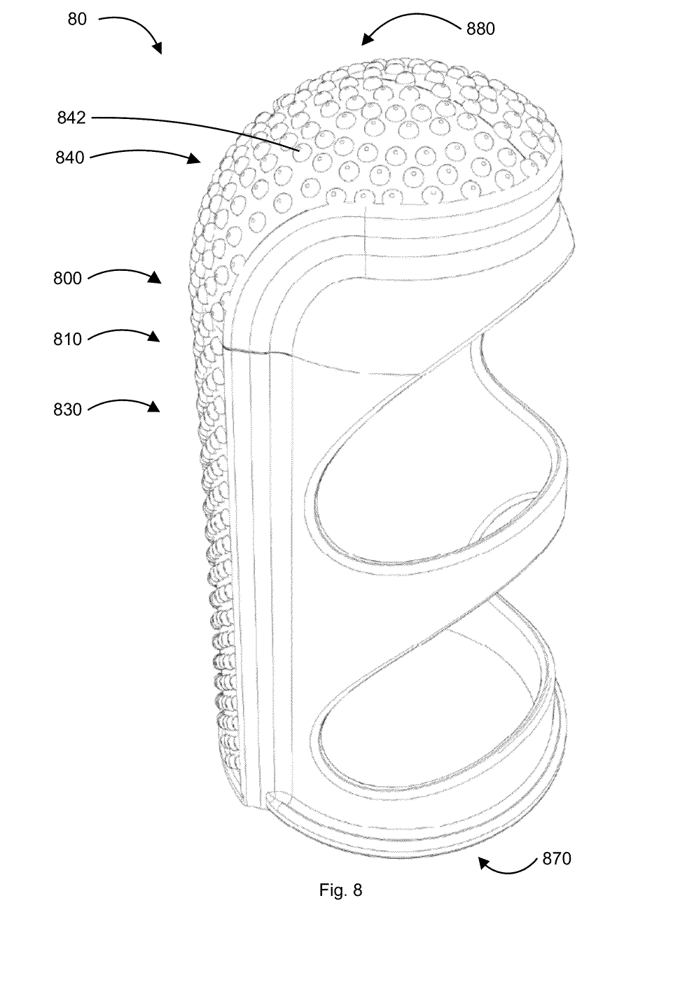

FIG. 8 illustrates a perspective view of another embodiment of the invention. Device 80 has a textured region 830 on an exterior surface 810 of a body 800. The textured region 830 is comprised of relatively small, semi-spherical features 840 having a projection 842 extending from the feature 840 away from the body 800. The coarseness of the textured region 830 can be modified by adjusting the radius of the semi-spherical features 840, the height or thickness of the projection 842, and/or by varying the distance between adjacent features 840 and/or the material of the features 840.

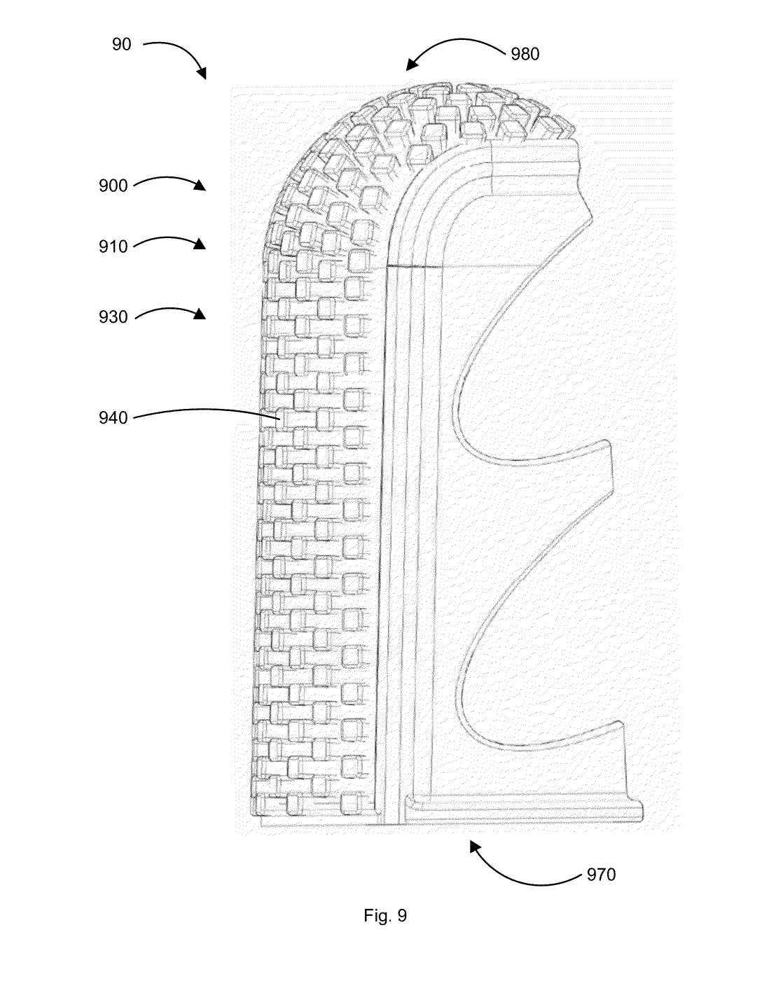

FIG. 9 illustrates a side view of another embodiment of the invention. Device 90 has a textured region 930 on an exterior surface 910 of a body 900. The textured region 930 is comprised of generally flat features 940, such as rectangular prisms. The coarseness of the textured region 930 can be modified by adjusting the size of the features (length, width, and/or height), and/or by varying the distance between adjacent features 940.

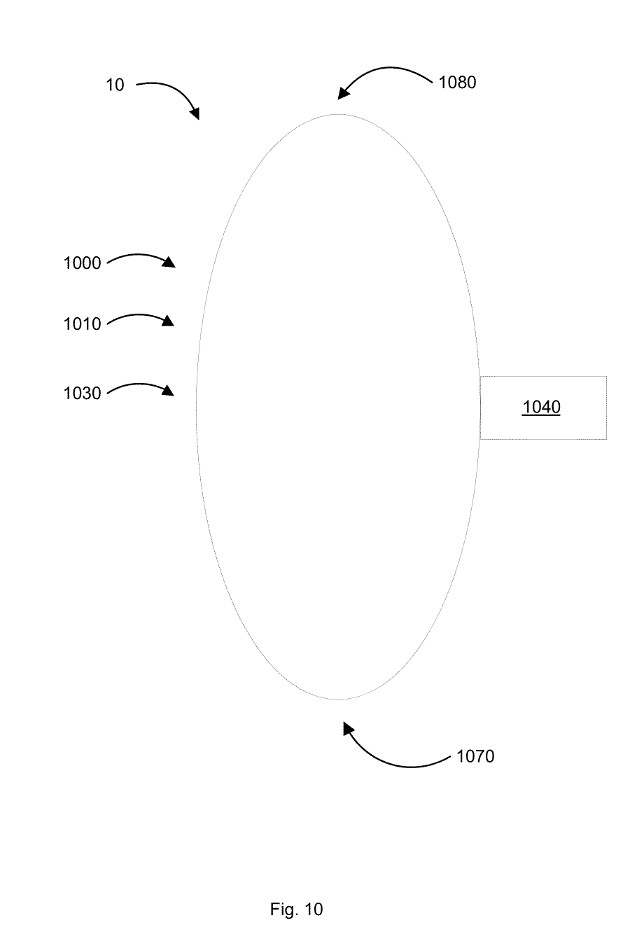

FIG. 10 illustrates a side view of another embodiment of the invention. Device 10 has a textured region 1030 on an exterior surface 1010 of a body 1000. As illustrated, the body 1000 is optionally closed and does not include a cavity for a finger. In some embodiments, the body 1000 includes a cavity (not shown) for receiving a finger, similar to the cavities described above (e.g., in FIG. 1). Likewise, the body 1000 can include an aperture (not shown) in a proximal portion 1070 of the body 1000, similar to the apertures described above (e.g. in FIG. 1). The body 1000 has a handle member 1040 that allows a patient to hold the device 10 and to rub the device against a scar or other treatment area. The patient can hold the device 10 by the handle member 1040 alone or can use the handle member 1040 while the device 10 is mounted on a finger. The handle member 1040 can be a block, a knob, or other shape that allows a person to hold the device 10.

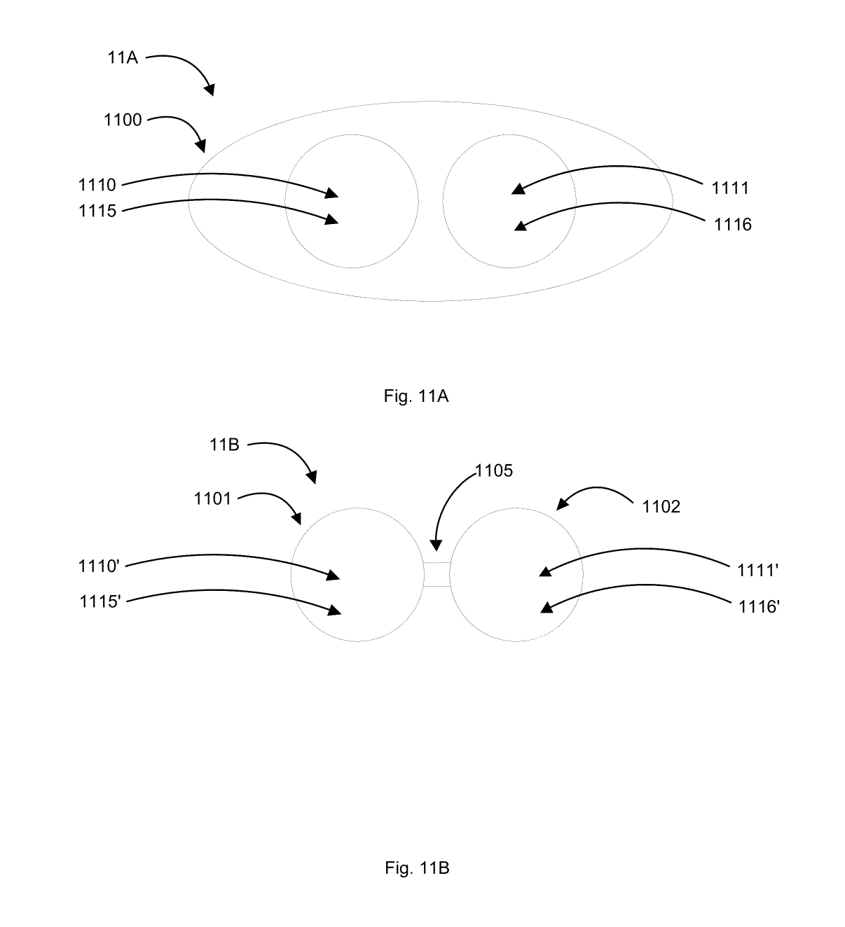

FIGS. 11A and 11B illustrate a bottom view of exemplary scar treatment thimble devices 11A and 11B, respectively. Device 11A has a body 1100 that defines a first aperture 1110 for receiving a first finger and a second aperture 1111 for receiving a second finger. The body 1100 has at least one textured region (not shown) with features that provide a coarseness as described above. In some embodiments, the body 1100 has two, three, four, or more textured regions (not shown). The textured regions and/or features can be made out of the same or different materials as other textured regions on the body 1100. In addition, the textured region(s) can correspond to a portion of a treatment regimen for treating a scar or other dermatological feature. A person can wear the device 11A by inserting a first finger though the first aperture 1110 and into a first cavity 1115 in the body 1100, and by inserting a second finger through the second aperture 1111 and into a second cavity 1116. Distal portions (not shown) of the first cavity 1115 and/or the second cavity 1116 can be shaped to conform to a fingertip, as described in other embodiments. In some embodiments, the body 1100 defines three or more apertures and respective cavities for receiving three or more fingers.

With respect to FIG. 11B, the device 11B includes a first body 1101 and a second body 1111 connected by a bridge 1105. The first body 1101 defines a first aperture 1110′ that connects to a first cavity 1115′. The second body 1102 defines a second aperture 1111′ that connects to a second cavity 1116′. Each body 1101, 1102 has a textured region (not shown) with features (not shown) that provide a coarseness as described above. In some embodiments, one or both bodies 1101, 1102 has multiple (e.g., two, three, four, or more) textured regions. Each textured region can be made out of the same material or a different material. In some embodiments, the textured region(s) correspond to a portion of a treatment regimen for treating a scar or other dermatological feature.

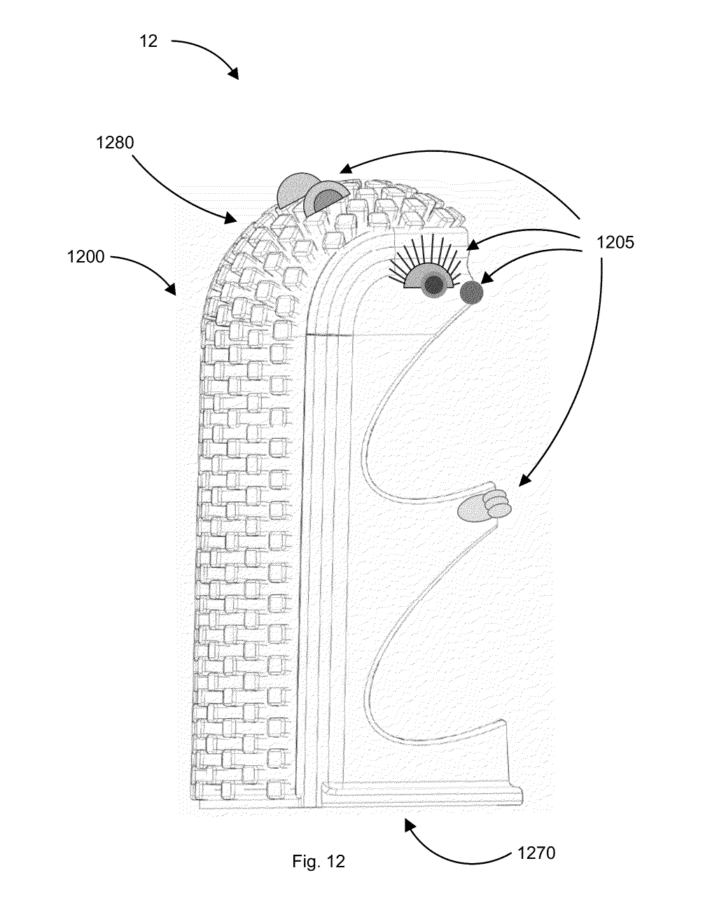

FIG. 12 illustrates a side view of another embodiment of the invention. As illustrated in FIG. 12, a device 12 includes animal or caricature features 1205 (e.g., nose, eyes, mouth, ears, paws, etc.) on a body 1200. The animal or caricature features 1205 can be amusing or less intimidating for a child when using the device 12. In some embodiments, a cartoon character or a superhero likeness is disposed on the device 12. In some embodiments, the body itself 1280 is formed to resemble an animal shape. In some embodiments, the device 12 can have a fun color (pink, yellow, blue, etc.) or pattern (polka dot, stripe, plaid, etc.) that can be appropriate for a child. The device 12 can have various textured regions, features, and materials as described herein.

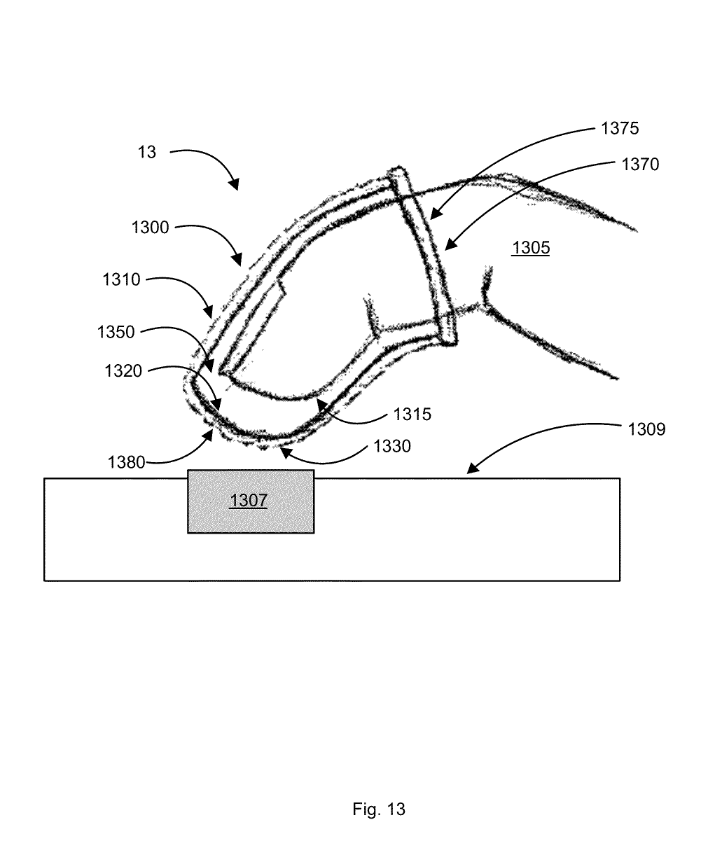

FIG. 13 illustrates a non-detailed view of a device 13 on a finger 1305 of a patient. The patient mounts the device 13 on the finger 1305 by inserting a fingertip 1315 through an aperture 1375 in a proximal end 1370 of a body 1300. The patient then slides the device 13 down the finger 1305 such that fingertip 1315 passes through a cavity 1350 and touches an interior surface 1320 of a distal end 1380 of the body 1300. As illustrated, the interior surface 1320 of the distal end 1380 of the body 1300 conforms to the fingertip 1315. For treatment, the patient rubs a textured region 1330 on an exterior surface 1310 of the body 1300 against a scar 1307 (or other dermatological condition) on a patient's body 1309. In some embodiments, the device 13 is adapted to be worn on two or more fingers 1305.

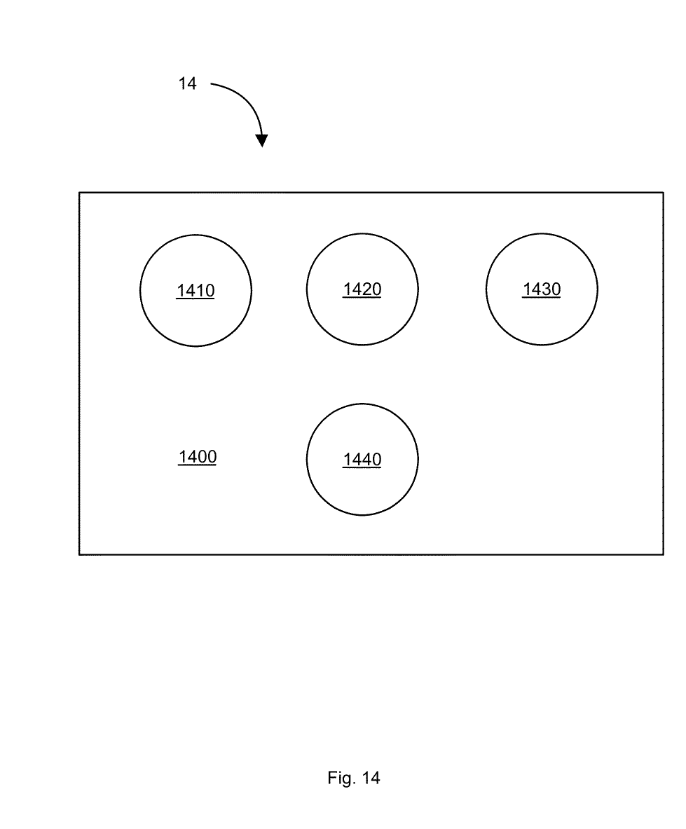

FIG. 14 illustrates a kit 14 for treating a dermatological condition. The kit 14 includes a housing 1400 containing a first device 1410, a second device 1420, and a third device 1430. The devices 1410, 1420, and 1430 can be substantially similar to one or more of the devices described above. For example, the devices 1410, 1420, and 1430 can be substantially similar to the device 10. The devices 1410, 1420, and 1430 can have textured regions (not shown) having the same or different coarseness. For example, device 1410 can have a textured region (not shown) with a first coarseness, device 1420 can have a textured region (not shown) with a second coarseness, and device 1430 can have a textured region (not shown) with a third coarseness. In some embodiments, the devices 1410, 1420, and 1430 have textured regions that are progressively coarser. For example, device 1410 can have a textured region that is relatively fine or non-coarse; device 1420 can have a textured region that his incrementally more course or rough than that of device 1410; and device 1430 can have a textured region that his incrementally more course or rough than that of device 1420. In other words, device 1410 can be the least coarse, device 1430 can be the most coarse, and device 1420 can have a “middle” coarseness. Each device 1410, 1420, and 1430 can be made out of the same or different materials as described above.

Similarly, each device 1410, 1420, and 1430 has the same or different feature shape (not shown). For example, device 1410 can have features (not shown) that are oval prisms (e.g., as illustrated in FIG. 1) while device 1420 can have features (not shown) that are semi-spheres (e.g., as illustrated in FIG. 7). Device 1430 can have features (not shown) that are oval prisms, semi-spheres, ridges, another shape or a combination thereof. The features of each device 1410, 1420, and 1430 can be arranged in a pattern, randomly, or a combination thereof.

The texture/coarseness of the devices 1410, 1420, and 1430 can correspond to a step or portion of a treatment regimen. For example, a patient can use device 1410 for a first portion of a treatment regimen (e.g., first 1-2 weeks) followed by device 1420 for a second portion of a treatment regimen (e.g., second 1-2 weeks) and device 1430 for a third portion of a treatment regimen (e.g., third 1-2 weeks). Additional devices can be provided for additional portions of a treatment regimen. The devices 1410, 1420, and 1430 can have writing, coloring, or another indicator to connect the appropriate device with the appropriate portion of the treatment regimen. For example, each device 1410, 1420, and 1430 can have a number inscribed on its surface to designate the week number to use the appropriate device 1410, 1420, and 1430 (e.g., device 1410 has a “1” inscribed on its surface, etc.). In some embodiments, one or more of devices 1410, 1420, and 1430 has a textured surface having two or more regions with a different coarseness (e.g., similar to device 50 in FIG. 5). In some embodiments, one or more of devices 1410, 1420, and 1430 has a handle and/or does not include cavity or aperture for receiving a finger. In some embodiments, one or more of devices 1410, 1420, and 1430 has a cavity and aperture for receiving two or more fingers.

In some embodiments, the kit 14 includes a cream 1440 that can be used to treat the dermatological condition together or in combination with the devices 1410, 1420, and 1430. The cream 1440 can include one, some, or all of the ingredients in Table 1. It is noted that the weight percentages provided in Table 1 are examples and are not intended to be exhaustive. For example, the cream 1440 can include plus or minus 1%, 2.5%, 5%, 10%, or 15% of the weight percentage of any ingredient listed in Table 1. The cream 1440 can have a pH of about 5.9 (at 25° C.) plus or minus 1%, 2.5%, 5%, 10%, or 15% and it can have a viscosity of about 200,000 cps plus or minus 1%, 2.5%, 5%, 10%, or 15%.

TABLE 1

| | Weight | |
|---|---|---|
| Ingredient | Percent | Function |
| Deionizied water | 57.30 | Vehicle |
| Glycerine | 5.00 | Humectant |
| Propanediol | 2.00 | Solvent moisturizer |
| SabiWhite ™ | 0.20 | Skin lightener, |
| (tetrahydrocurcumin 95%) | | antioxidant |
| (Sabinsa Corporation) | | |
| Aloe barbedensis | 2.00 | Anti-inflammatory |
| Carbopol ® Ultrez 10 (carbomer) | 0.80 | Rheology, viscosity |
| (Lubrizol Corporation) | | |
| Vital ET ™ | 2.50 | VE phosphate non- |
| (disodiumLauriminodipropionate | | steroidal anti- |
| tocopheryl phosphates) | | inflammatory, source |
| (Ashland Inc.) | | of Vitamin E |
| Allantoin | 0.50 | Stimulates new tissue |
| | | growth, wound |
| | | healing |
| Muira puama (ptychopetalum | 0.50 | Increase blood flow, |
| olacoides bark/root extract (and) | | antiseptic, |
| glycerin (and) water) | | antibacterial |
| Cutina ® GMS V (glyceryl | 1.00 | Emulsifier |
| stearate) (BASF Corporation) | | |
| Phenoxyl T (cetearyl alcohol | 2.00 | Emulsifier |
| (and) ceteareth-20) | | |
| Alpha-bisabolol | 0.20 | Non-steroidal anti- |
| | | inflammatory |
| Cocoa butter (theobroma cacao | 2.00 | Reduces degeneration |
| seed butter) | | of skin cells and |
| | | restores skin flexibility |
| Cremelin ® PURA (vegetable | 1.00 | Natural petrolatum |
| oils) (CREMER OLEO GmbH & | | |
| Co. KG) | | |
| Almond oil (prunus amygdalus | 1.00 | Emollient |
| dulcis) | | |
| Olive oil (olea europaea) | 1.00 | Soothing, promotes oil |
| | | spreading and skin |
| | | smoothness |
| Jojoba oil (simmondsia chinesis) | 8.00 | Wax esters for |
| | | antioxidant, moisture |
| | | emollient, improves |
| | | skin elasticity |
| Dow Corning ® 200, 100 cSt | 0.50 | Silicone spreading |
| (dimethicone) (Dow Corning | | |
| Corporation) | | |
| Freshcolat ® MGA (menthone | 1.00 | Skin coolant and |
| glycerine acetal) (Symrise AG) | | refreshant |
| Triethanolamine 99% | 0.60 | pH adjustment |
| Escalol ® 557 Octinoxate | 1.00 | UV absorber |
| (Ashland Inc.) | | |
| Germaben ® II (propylene glycol | 1.00 | Preservative |
| (and) diazolidinyl urea (and) | | |
| methylparaben (and) | | |
| propylparaben) (Sutton | | |
| Laboratories) | | |
| Phytotal ™ AI PS (glycerin, aqua, | 2.30 | Reduces visible and |
| butylene glycol, euphrasia | | physical signs of |
| officinalis extract, melissa | | irritation |
| officinalis extract, magnolia | | |
| biondii extract, lecithin) (Croda | | |
| International PLC) | | |
| SymSitive ® 1609 (pentylene | 3.00 | Reduces neuropathic |
| glycol, 4-t-butylcyclohexanol) | | pain (e.g., stinging |
| (Symrise AG) | | and burning) |
| Cucumber phytobasic in | 2.30 | Astringent/skin |
| glycerine (cucumis sativa extract) | | tightening |
| Pro-Lipo ™ Neo (propanediol | 1.30 | Pro-liposome |
| (and) lecithin) (Unipex Group | | encapsulation skin |
| Inc.) | | penetrant; increases |
| | | skin penetration and |
| | | bioavailability of |
| | | entrapped hydrophilic |
| | | and/or lipophilic active |
| | | ingredients for better |
| | | and faster results |

The cream 1440 can be infused or stored in a silicone (or similar) elastomer sheet or pad, which can be available in various sizes to use as a dressing over a surgical or traumatic scar. The cream 1440 can be located in a recessed compartment within the elastomer sheet or pad. The elastomer sheet or pad can be which is stored prior to clinical application by using an impermeable or semipermeable peel away covering. For example, the elastomer sheet or pad can be sized and shaped to fit over a caesarian section scar. The sheet or pad can be applied over the entire length of the scar for several weeks following the caesarian section procedure, allowing the scar (and the patient) to benefit from the cream contained in the sheet or pad. Additionally, the sheet or pad can retain moisture, which can soften a scar and protect the skin from post-surgical hypersensitivity.

The present invention should not be considered limited to the particular embodiments described above, but rather should be understood to cover all aspects of the invention as fairly set out in the present claims. Various modifications, equivalent processes, as well as numerous structures to which the present invention may be applicable, will be readily apparent to those skilled in the art to which the present invention is directed upon review of the present disclosure. The claims are intended to cover such modifications.

What is claimed is:

1. An apparatus for treating skin, the apparatus comprising:
a substantially cylindrically shaped body having an axial length and a width and having a wall of a finite thickness, and defining a cylindrical cavity suited to receive a finger, said walls having an interior surface defined by said cavity, as well as an exterior surface;
said body further having a first end and a second end at opposing ends of said axial length of said body, said first end comprising an aperture to allow a finger to pass through said aperture and into the cavity along said axial length, and the interior surface of the second end conforms to a tip of a finger;
said body additionally comprising at least one side opening in a side of said wall; and
a textured region on at least a portion of the exterior surface of the body.

2. The apparatus of claim 1 wherein the body is comprised of silicone.

3. The apparatus of claim 1 wherein the body of the apparatus is somewhat tapered so as said first end is wider than said second end and the second end that conforms to a tip of a finger has a curved interior surface.

4. The apparatus of claim 3 wherein said side opening is disposed in a portion of said wall between said first and second ends.

5. The apparatus of claim 1, said first end being proximal to a user's body and said second end being distal to said user's body.

6. The apparatus of claim 1 wherein the textured region is comprised of raised features extending from the exterior surface of the body.

7. The apparatus of claim 6 wherein at least some of the raised portions have an elongated shape.

8. The apparatus of claim 6 further comprising a first group of the raised portions oriented in a first direction and a second group of the raised portions oriented in a second direction wherein the second direction is orthogonal to the first direction.

9. The apparatus of claim 8 wherein the textured region includes a grid having a first section comprised of the first group of the raised portions and a second section comprised of the second group of the raised portions, the first section adjacent to the second section.

10. The apparatus of claim 6 wherein at least some of the raised portions have a spherical section shape.

11. The apparatus of claim 1, further comprising at least one support member disposed across said side opening and extending from a first position on said walls to a second position on said walls so as to divide said side opening into at least a pair of side openings and offering structural support to said body in the vicinity of said side opening.

12. An apparatus for treating skin, the apparatus comprising:
a body having a cavity to receive a finger, the body having an interior surface and an exterior surface and a proximal end and a distal end, wherein the interior surface is exposed to the cavity and the proximal end defines an aperture to allow a finger to pass through to the cavity;
a first textured region on a first portion of the exterior surface of the body, the first textured region having a first coarseness; and
a second textured region on a second portion of the exterior surface of the body, the second textured region having a second coarseness, wherein the second coarseness is greater than the first coarseness.

13. The apparatus of claim 12 wherein the body is comprised of silicone.

14. The apparatus of claim 12 further comprising a third textured region on a third portion of the exterior surface of the body, the third textured region having a third coarseness, wherein the third coarseness is greater than the second coarseness.

15. The apparatus of claim 12 wherein the interior surface of the distal end conforms to a tip of a finger.

16. The apparatus of claim 12 wherein the first textured region and the second textured region each extends from the proximal end to the distal end of the body, the first textured region disposed laterally across an exterior surface of the body from the second textured region.

17. The apparatus of claim 16 wherein the body includes a support member disposed between the proximal end and the distal end and the body defines a first opening between the proximal end and the support member and a second opening between the distal end and the support member.

18. The apparatus of claim 17 wherein the first opening is in alignment with the second opening along an axis running from the proximal end to the distal end of the body.

19. The apparatus of claim 18 wherein the first opening is about the same size as the second opening.

20. A kit for treating skin, the kit comprising:
(a) a first apparatus comprising:
a first body having a first cavity to receive a finger, the first body having a first interior surface and a first exterior surface and a first proximal end and a first distal end, wherein the first interior surface is exposed to the first cavity and the first proximal end defines a first aperture to allow a finger to pass through to the first cavity; and
a first textured region on the first exterior surface of the first body, the first textured region having a first coarseness;
(b) a second apparatus comprising:
a second body having a second cavity to receive a finger, the first body having a second interior surface and a second exterior surface and a second proximal end and a second distal end, wherein the second interior surface is exposed to the second cavity and the second proximal end defines a second aperture to allow a finger to pass through to the second cavity; and
a second textured region on the second exterior surface of the second body, the second textured region having a second coarseness,
wherein the second coarseness is greater than the first coarseness; and
(c) a container including a therapeutic cream for treating the skin.

21. The kit of claim 20, wherein the first textured region is comprised of raised portions extending from the first exterior surface of the first body and the second textured region is comprised of raised portions extending from the second exterior surface of the second body.

22. An apparatus for treating skin, the apparatus comprising:
an elongated body comprised of an elastomer;
a first textured region on a first portion of an exterior surface of the body, the first textured region having a first coarseness;
a second textured region on a second portion of the exterior surface of the body, the second textured region having a second coarseness, wherein the second coarseness is greater than the first coarseness; and
a handle member connected to the body.
